(19) United States
(12) Patent Application Publication
(10) Pub. No.: US 2026/0155677 A1
(43) Pub. Date: Jun. 4, 2026

(54) ATTACHMENT OF ENERGY HARVESTING DEVICE

(71) Applicant: Nokia Technologies Oy, Espoo (FI)

(72) Inventors: Yonggang WANG, Shanghai (CN); Muhammad Majid BUTT, Naperville, IL (US); Nitin MANGALVEDHE, Naperville, IL (US)

(21) Appl. No.: 19/127,438

(22) PCT Filed: Dec. 13, 2022
(86) PCT No.: PCT/CN2022/138836

§ 371 Date: May 6, 2025

(51) Int. Cl. H02J 50/00; H02J 50/80; H04W 8/00; H04W 60/00

(52) U.S. Cl. CPC H02J 50/001; H02J 50/80; H04W 8/005; H04W 60/00

(57) ABSTRACT

Embodiments of the present disclosure relate to attachment of an energy harvesting device to a terminal device. The terminal device receives, from a network device, an information message for attachment of at least one energy harvesting device to the terminal device. In turn, the terminal device receives, from the network device, a message indicating that the at least one energy harvesting device is attached to the terminal device.

### FIELD

Various example embodiments relate to the field of telecommunication and in particular, to a terminal device, a network device, methods, apparatuses and computer readable storage media for attachment of an energy harvesting device.

### BACKGROUND

A candidate technology for ultra-low energy or zero-energy devices is a backscattering, whereby an illuminator may transmit a radio frequency (RF) signal which illuminates an energy harvesting device, the energy harvesting device modulates the incident RF signal with an information-bearing signal, and the reflected signal is demodulated at a receiver. All backscattering systems are Reader Talks First (RTF). That is, the energy harvesting device modulates the reflection wave with its stored information only after receiving the signal sent by the illuminator.

Radio Frequency Identification (RFID) based on Electronic Product Code (EPC) Generation-2 (Gen2) can support a data rate of 40 kbps to 640 kbps from energy harvesting device to reader with a sensitivity of −85 dBm. Typical rates in a lab vary between 60-70 kbps using Miller (M=4) encoding. For RFID, typical ranges of 3 m can be achieved using passive transponders and ranges up to 30 m can be achieved using active transponders. All long-range systems operate using Ultra High Frequency (UHF) or microwave frequencies and use back scattered modulation to communicate with the reader.

From the cost, complexity and life cycle point of view, passive Internet of Things (IoT) in the Fifth Generation System (5GS) with RF harvesting and backscattering is the optimized solution. Radio technology needs to be studied, such as to support backscattering communication and RF energy harvesting, or to extend the communication range of passive devices. For example, the harvested energy may be only used to provide an auxiliary enhancement to the backscattering signal but not active communication.

### SUMMARY

In general, example embodiments of the present disclosure provide a solution for attachment of an energy harvesting device.

In a first aspect, there is provided a terminal device. The terminal device comprises at least one processor and at least one memory storing instructions. When the instructions are executed by the at least one processor, the instructions cause the terminal device at least to: receive, from a network device, an information message for attachment of at least one energy harvesting device to the terminal device; and receive, from the network device, a message indicating that the at least one energy harvesting device is attached to the terminal device.

In a second aspect, there is provided a network device. The network device comprises at least one processor and at least one memory storing instructions. When the instructions are executed by the at least one processor, the instructions cause the network device at least to: transmit an information message for attachment of at least one energy harvesting device to a terminal device; receive information associated with the at least one energy harvesting device and an identity of the terminal device; determine, based at least on the information and the identity of the terminal device, to attach the at least one energy harvesting device to the terminal device; and transmit, to the terminal device, a message indicating that the at least one energy harvesting device is attached to the terminal device.

In a third aspect, there is provided a method implemented at a terminal device. The method comprises: receiving, at a terminal device from a network device, an information message for attachment of at least one energy harvesting device to the terminal device; and receiving, from the network device, a message indicating that the at least one energy harvesting device is attached to the terminal device.

In a fourth aspect, there is provided a method implemented at a network device. The method comprises: transmitting, from a network device to a terminal device, an information message for attachment of at least one energy harvesting device; receiving information associated with the at least one energy harvesting device and an identity of the terminal device; determining, based at least on the information and the identity of the terminal device, to attach the at least one energy harvesting device to the terminal device; and transmitting, to the terminal device, a message indicating that the at least one energy harvesting device is attached to the terminal device.

In a fifth aspect, there is provided an apparatus. The apparatus comprises: means for receiving, at a terminal device from a network device, an information message for attachment of at least one energy harvesting device to the terminal device; and means for receiving, from the network device, a message indicating that the at least one energy harvesting device is attached to the terminal device.

In a sixth aspect, there is provided an apparatus. The apparatus comprises: means for transmitting, from a network device to a terminal device, an information message for attachment of at least one energy harvesting device; means for receiving information associated with the at least one energy harvesting device and an identity of the terminal device; means for determining, based at least on the information and the identity of the terminal device, to attach the at least one energy harvesting device to the terminal device; and means for transmitting, to the terminal device, a message indicating that the at least one energy harvesting device is attached to the terminal device.

In a seventh aspect, there is provided a non-transitory computer readable medium comprising program instructions for causing an apparatus to perform at least the method according to any one of the above third to fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication network in which example embodiments of the present disclosure may be implemented;

FIG. 2 illustrates a signaling chart illustrating a process for attachment of an energy harvesting device according to some example embodiments of the present disclosure;

FIG. 3 illustrates a signaling chart illustrating a process for attachment of an energy harvesting device according to some other example embodiments of the present disclosure;

FIG. 4 illustrates a signaling chart illustrating a process for attachment of an energy harvesting device according to still other example embodiments of the present disclosure;

FIG. 5 illustrates a flowchart of a method implemented at a terminal device according to some example embodiments of the present disclosure;

FIG. 6 illustrates a flowchart of a method implemented at a network device according to some example embodiments of the present disclosure;

FIG. 7 illustrates a simplified block diagram of an apparatus that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Details of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

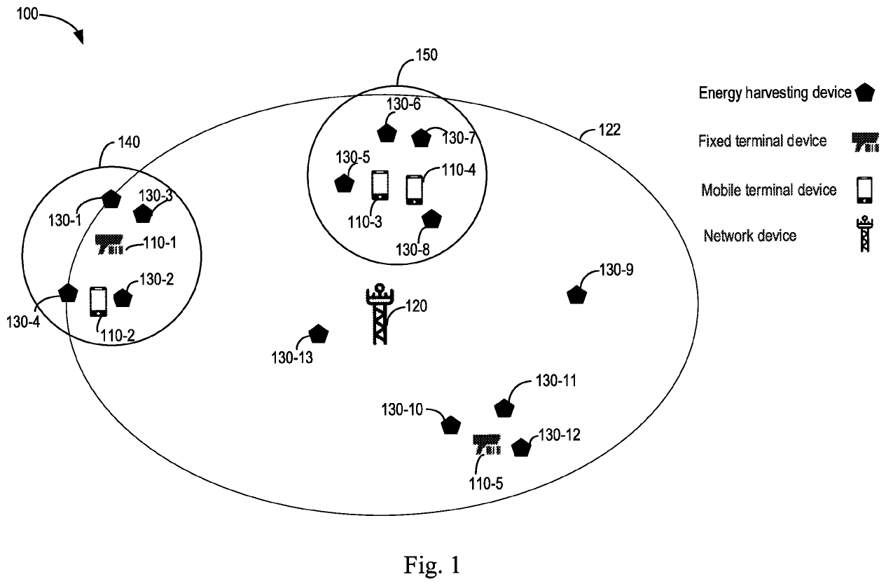

FIG. 1 illustrates an example communication network 100 in which example embodiments of the present disclosure may be implemented. The communication network 100 may comprise terminal devices 110-1, 110-2, 110-3, 110-4 and 110-5. Hereinafter, for brevity, the terminal devices 110-1, 110-2, 110-3, 110-4 and 110-5 may be collectively referred to as terminal devices 110 or individually referred to as a terminal device 110.

The communication network 100 may also comprise a network device 120. The network device 120 may provide a coverage area 122, which is also referred to as a cell 122. The network device 120 communicates with the terminal devices 110 in the cell 122.

The communication network 100 may also comprise energy harvesting devices 130-1, 130-2, 130-3, 130-4, 130-5, 130-6, 130-7, 130-8, 130-9, 130-10, 130-11, 130-12 and 130-13. Hereinafter, for brevity, the energy harvesting devices 130-1, 130-2, 130-3, 130-4, 130-5, 130-6, 130-7, 130-8, 130-9, 130-10, 130-11, 130-12 and 130-13 may be collectively referred to as energy harvesting devices 130 or individually referred to as an energy harvesting device 130.

In some example embodiments, the terminal devices 110 may provide service to one or more energy harvesting devices 130 in their respective service areas. For example, the terminal devices 110-1 and 110-2 may provide service to the energy harvesting devices 130-1 to 130-4 in a service area 140. The terminal devices 110-3 and 110-4 may provide service to the energy harvesting devices 130-5 to 130-8 in a service area 150.

It is to be understood that the number of network devices, terminal devices and energy harvesting devices is only for the purpose of illustration without suggesting any limitations. The network 100 may include any suitable number of network devices, terminal devices and energy harvesting devices adapted for implementing embodiments of the present disclosure.

Communications in the communication network 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM), passive communication protocols such as protocol for RFID, comprising but not limited to: ISO/IEC 14443, ISO/IEC 15693, ISO/IEC 18000, EPC Gen2 and/or any other technologies currently known or to be developed in the future.

In some example embodiments, at least one of the terminal devices 110 may be a terminal device with capability of an illuminator.

In some example embodiments, at least one of the terminal devices 110 may be a terminal device with capability of a receiver or a reader. In the present disclosure, terms “receiver” and “reader” may be used interchangeably.

In some example embodiments, the illuminator may transmit an RF signal which illuminates an energy harvesting device 130. The RF signal which illuminates the energy harvesting device 130 is also referred to as an illumination signal. The energy harvesting device may modulate the incident RF signal with an information-bearing signal and reflect the modulated signal. The reflected signal may be demodulated at the receiver.

In some example embodiments, at least one of the terminal devices 110 may be a terminal device with capability both of the reader and the illuminator. For brevity, the terminal device with capability both of the reader and the illuminator is also referred to as a “reader/illuminator”.

In some example embodiments, at least one of the terminal devices 110 may be a reader/illuminator with fixed deployment, which is also referred to as a fixed reader/illuminator. For example, the terminal device 110-1 may be a fixed reader/illuminator deployed in the area 140 with a high density of energy harvesting devices 130-1 to 130-4. For another example, the terminal device 110-5 may be a fixed reader/illuminator which provides service to the energy harvesting devices 130-10 to 130-12.

In some example embodiments, at least one of the terminal devices 110 may be a reader/illuminator with mobile deployment, which is also referred to as a mobile reader/illuminator. For example, the terminal device 110-2 may be a mobile reader/illuminator deployed in the area 140. The terminal devices 110-3 and 110-4 may provide service to the energy harvesting devices 130-5 to 130-8 which come into the area 150.

In some example embodiments, a mobile reader/illuminator may be used for “probabilistic” or “best effort” coverage when a fixed reader/illuminator is not available to provide service.

In some example embodiments, the network device 120 may act as a reader/illuminator, an illuminator or a receiver.

In some example embodiments, at least one of the energy harvesting devices 130 may be an active device.

Alternatively, in some example embodiments, at least one of the energy harvesting devices 130 may be a passive device. For example, the at least one of the energy harvesting devices 130 may be a passive IoT device, such as a tag.

As shown in FIG. 1, in the cell 122, the energy harvesting devices 130 are non-uniformly distributed with high density in some areas (such as in the areas 140 and 150) and low in other areas. Some of the energy harvesting devices 130 may be situated nearer to the network device 120. However, some of the energy harvesting devices may be situated farther away from the network device 120. For example, the energy harvesting device 130-13 is nearer to the network device 120 while the energy harvesting devices 130-1 to 130-4 are farther away from the network device 120.

Although the energy harvesting device 130 is an element of the 5GS, it does not have some characteristics of the 5G terminal devices. For example, the energy harvesting device 130 may not be able to receive and parse most of the communication in 5G NR due to cost and/or complexity constraints. The energy harvesting device 130 may be able to only receive some selected communication messages on the preconfigured frequency. Thus, the energy harvesting device 130 may have only limited communication capability with the network device 120. For example, the energy harvesting device 130 may be able to communicate with the network device 120 only via backscattering.

Due to the limitation of the link budget, the network device 120 itself should not always be used as illuminator for backscattering as it can create a lot of interference to other terminal devices. For the energy harvesting device 130 at the cell edge, if the reflected signal can be received and correctly decoded by the network device 120, the power the network device 120 uses to illuminate the energy harvesting device 130 may need to be very large, which can interfere with all other communications at the same frequency.

A possible solution is to deploy multiple illuminators as well as receivers (or readers) depending on density of the energy harvesting devices 130. These illuminators and receivers are 5G terminal devices. They can communicate with the network device 120 in a normal way. The nearby deployed illuminator and receiver can minimize the power required for illumination. For example, an illuminator covering only energy harvesting devices within ten meters may transmit power that does not create a lot of interference to the UEs and energy harvesting devices in other areas.

Based on different use cases and requirements, illuminators as well as receivers may be fixed and powered by a fixed power source, or may be mobile and powered by a battery or another type of energy storage. In some cases, when energy harvesting devices no longer exist around some of the illuminators as well as receivers, they can be deactivated by the system or opportunistically illuminated and/or received by mobile terminal devices located nearby.

When an energy harvesting device is admitted into the 5GS, multiple illuminators as well as receivers are already deployed in the system depending on density of energy harvesting devices. Before being able to communicate with the 5GS, several needs should be addressed. For example, there is a need to discover energy harvesting devices as well as readers/illuminators first and configure illuminator-receiver pairs for each energy harvesting device based on the information. For another example, there is a need to detect any expiration of connectivity of an energy harvesting device and/or start or restart procedures for establishing/reestablishing connectivity of the energy harvesting device.

Example embodiments of the present disclosure provide a solution for attachment of (e.g., an association that establishes or enables some form of communication with) at least one energy harvesting device. According to one solution, a terminal device receives, from a network device, an information message for attachment of at least one energy harvesting device to the terminal device. For example, the message may indicate to the terminal device that the at least one energy harvesting device is attached to the terminal device. In this way, an energy harvesting device may be associated with a terminal device acting as a reader/illuminator. Thus, the network device may obtain information associated with the energy harvesting device through the terminal device.

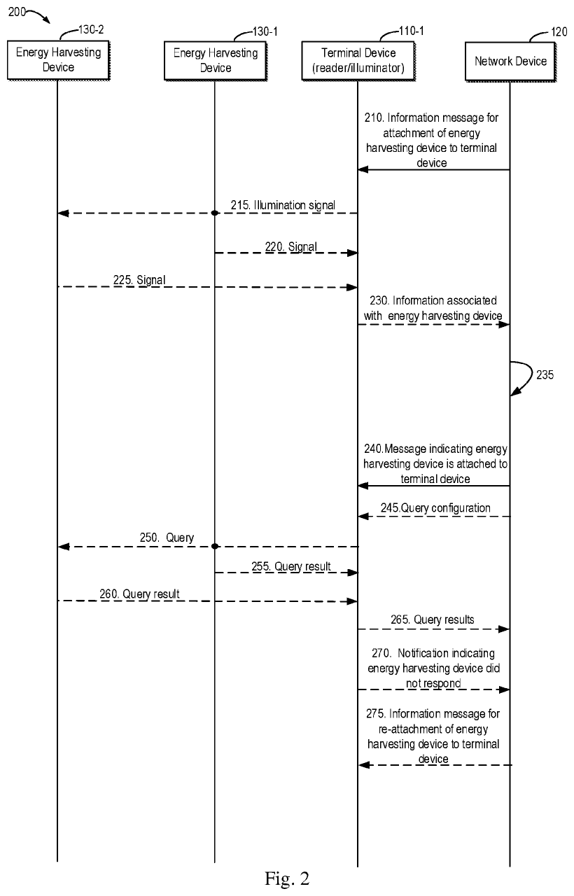

Hereinafter, details of the present disclosure will be described with reference to FIGS. 2 to 8.

FIG. 2 illustrates a signaling chart illustrating a process 200 for attachment of at least one energy harvesting device in accordance with some example embodiments of the present disclosure. For the purpose of discussion, the process 200 will be described with reference to FIG. 1. The process 200 may involve the terminal device 110, the network device 120 and the energy harvesting devices 130 in FIG. 1. Hereinafter, the process 200 will be described using the terminal device 110-1, the network device 120 as well as the energy harvesting devices 130-1 and 130-2 for example.

In the process 200, the terminal device 110-1 is implemented as a reader/illuminator.

As shown in FIG. 2, the network device 120 transmits 210 an information message for attachment of at least one energy harvesting device 130 to the terminal device 110.

In some example embodiments, the network device 120 may broadcast information message in system information so that all the terminal device 110 in the cell 122 may receive the information message. For example, the network device 120 may broadcast the information message in system information block (SIB), or through the multimedia broadcast multicast service (MBMS).

In some example embodiments, the information message may comprise at least one of the following:
time when an illumination signal is to be transmitted,
a bandwidth part (BWP) on which the illumination signal is to be transmitted,
a type of the at least one energy harvesting device 130 which will receive the illumination signal, or
a set of identities of energy harvesting devices comprising the at least one energy harvesting device 130.

In some example embodiments, the set of identities of energy harvesting devices may indicate a range of the identities of the energy harvesting devices to be discovered by the terminal device 110.

Accordingly, the terminal device 110-1 receives the information message for attachment of at least one energy harvesting device 130 from the network device 120.

In example embodiments where the terminal device 110-1 is implemented as a reader/illuminator, the terminal device 110-1 may transmit 215 an illumination signal based on the information message. The illumination signal comprises a request for the attachment.

In some example embodiments, the terminal device 110-1 may broadcast the illumination signal so that more than one energy harvesting device may receive the illumination signal. For example, the energy harvesting devices 130-1 and 130-2 may receive the illumination signal.

In some example embodiments, the illumination signal may comprise an identity of the terminal device 110-1.

In turn, the terminal device 110-1 may receive 220 a signal from the energy harvesting device 130-1 based on the information message. The signal may comprise at least an identity of the energy harvesting device 130-1. Alternatively or additionally, the signal may comprise any other assistance information to be used for attachment of the energy harvesting device 130-1.

In example embodiments where the energy harvesting device 130-1 is a passive energy harvesting device, the signal from the energy harvesting device 130-1 may be a signal backscattered from the energy harvesting device 130-1. For example, the energy harvesting device 130-1 may modulate the received illumination signal with an information-bearing signal and backscatter the modulated signal. The information-bearing signal may comprise an identity of the energy harvesting device 130-1.

The terminal device 110-1 may demodulate the backscattered signal from the energy harvesting device 130-1.

In example embodiments where the energy harvesting device 130-1 is an active energy harvesting device, the signal from the energy harvesting device 130-1 may be a signal transmitted from the energy harvesting device 130-1.

Similarly, the terminal device 110-1 may receive 225 a signal from the energy harvesting device 130-2 based on the information message. The signal from the energy harvesting device 130-2 may comprise at least an identity of the energy harvesting device 130-2. The signal from the energy harvesting device 130-2 may be a signal backscattered or transmitted from the energy harvesting device 130-2.

Then, the terminal device 110-1 may transmit 230 information associated with the at least one energy harvesting device 130 and an identity of the terminal device 110-1 to the network device 120.

In some example embodiments, the information associated with the at least one energy harvesting device 130 may comprise at least one of the following: an identity of the at least one energy harvesting device 130, or a power measurement of the signal from the at least one energy harvesting device 130. For example, the information associated with the at least one energy harvesting device 130 may comprise at least one of the following: identities of the energy harvesting devices 130-1 and 130-2, or power measurements of the signals from the energy harvesting devices 130-1 and 130-2.

Upon receiving the information associated with the at least one energy harvesting device 130 and the identity of the terminal device 110-1, the network device 120 determines 235, based at least on the information and the identity of the terminal device 110-1, to attach the at least one energy harvesting device 130 to the terminal device 110-1. For example, the network device 120 may determine, based at least on the information and the identity of the terminal device 110-1, to attach at least one of the energy harvesting devices 130-1 and 130-2 to the terminal device 110-1.

In turn, the network device 120 transmits 240, to the terminal device 110-1, a message indicating that the at least one energy harvesting device 130 is attached to the terminal device 110-1.

In some example embodiments, the message indicating that the at least one energy harvesting device 130 is attached to the terminal device 110-1 may comprise the identity of at least one of the energy harvesting devices 130-1 and 130-2.

Upon receiving the message indicating that the at least one energy harvesting device 130 is attached to the terminal device 110-1, the attachment of the at least one energy harvesting device 130 to the terminal device 110-1 is completed.

In some example embodiments, the attachment of the at least one energy harvesting device 130 to the terminal device 110-1 determines which illuminator may need to be used for communication with an energy harvesting device 130 and which reader may need to listen to the energy harvesting device 130 when the illuminator is active. For example, in example embodiments where the energy harvesting device 130-1 is attached to the terminal device 110-1 acting the reader/illuminator, the terminal device 110-1 may need to be used for communication with the energy harvesting device 130-1 and listen to the energy harvesting device 130-1.

In some example embodiments, the network device 120 may transmit 245, to the terminal device 110-1, a query configuration for at least one attached energy harvesting device 130. For example, the network device 120 my broadcast the query configuration.

In some example embodiments, the query configuration may comprise at least one of the following:
an identity of the at least one attached energy harvesting device 130,
a cycle in which a query is to be transmitted, or
a bandwidth part on which the query is to be transmitted.

Upon receiving the query configuration, the terminal device 110-1 may transmit 250, based on the query configuration, a query to the at least one attached energy harvesting device 130. For example, terminal device 110-1 may broadcast the query so that the attached energy harvesting devices 130-1 and 130-2 may receive the query.

Alternatively, the network device 120 may transmit, based on the query configuration, a query to the at least one attached energy harvesting device 130.

In turn, the terminal device 110-1 may receive 255, based on the query configuration, a query result from the attached energy harvesting device 130-1. For example, the query result from the attached energy harvesting device 130-1 may comprise sensing information from the attached energy harvesting device 130-1.

Similarly, the terminal device 110-1 may receive 260, based on the query configuration, a query result from the attached energy harvesting device 130-2. For example, the query result from the attached energy harvesting device 130-2 may comprise sensing information from the attached energy harvesting device 130-2.

In turn, the terminal device 110-1 may transmit 265 the query results to the network device 120.

In some example embodiments, the at least one energy harvesting device 130 may be not attached to the terminal device 110-1 for example due to mobility of at least one of the following: the at least one energy harvesting device 130 or the terminal device 110-1. In other words, the at least one energy harvesting device 130 may be not within a communication range of the terminal device 110-1.

In some example embodiments, optionally, if the terminal device 110-1 detects the at least one energy harvesting device 130 does not respond to the terminal device 110-1, for example the query request, the terminal device 110-1 may transmit 270, to the network device 120, a notification indicating the at least one energy harvesting device 130 did not respond to the terminal device 110-1.

Upon receiving the notification, the network device 120 may optionally transmit 275 the information message for re-attachment of the at least one energy harvesting device 130 to the terminal device 110. For example, the network device 120 may broadcast the information message for re-attachment of the at least one energy harvesting device 130 to the terminal device 110.

In some example embodiments, the notification from the terminal device 110-1 may indicate the number of the energy harvesting devices 130 which did not respond to the terminal device 110-1. If the number exceeds a number threshold, the network device 120 may transmit the information message for re-attachment of the at least one energy harvesting device 130 to the terminal device 110-1.

In some example embodiments, the network device 120 may transmit the information message periodically so that one or more new or other energy harvesting device may attach to the terminal device 110. In such example embodiments, the network device 120 may transmit the information message periodically even if the network device 120 does not receive the notification from the terminal device 110-1.

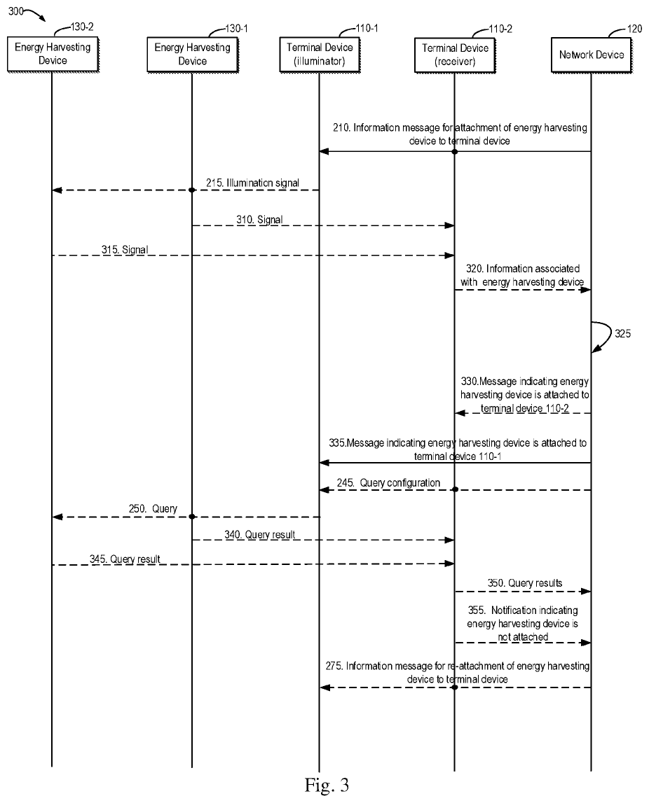

FIG. 3 illustrates a signaling chart illustrating a process 300 for attachment of at least one energy harvesting device in accordance with some other example embodiments of the present disclosure. For the purpose of discussion, the process 300 will be described with reference to FIG. 1. The process 300 may involve the terminal device 110, the network device 120 and the energy harvesting devices 130 in FIG. 1. Hereinafter, the process 300 will be described using the terminal device 110-1, the terminal device 110-2, the network device 120 as well as the energy harvesting devices 130-1 and 130-2 for example.

In the process 300, the terminal device 110-1 is implemented as an illuminator and the terminal device 110-2 is implemented as a reader.

The actions at 210, 215, 245, 250 and 275 in the process 300 are similar to those in the process 200. Thus, details of these actions are omitted for brevity.

The process 300 is different from the process 200 in actions at 310, 315, 320, 325, 330, 335, 340, 345, 350 and 355.

Specifically, the terminal device 110-2 may receive 310 a signal from the energy harvesting device 130-1 based on the information message. The signal from the energy harvesting device 130-1 may be a signal backscattered or transmitted from the energy harvesting device 130-1. The signal may comprise at least an identity of the energy harvesting device 130-1 and an identity of the terminal device 110-1. Alternatively or additionally, the signal may comprise any other assistance information to be used for attachment of the energy harvesting device 130-1.

Similarly, the terminal device 110-2 may receive 315 a signal from the energy harvesting device 130-2 based on the information message. The signal from the energy harvesting device 130-2 may comprise at least an identity of the energy harvesting device 130-2 and the identity of the terminal device 110-1. The signal from the energy harvesting device 130-2 may be a signal backscattered or transmitted from the energy harvesting device 130-2.

Then, the terminal device 110-2 may transmit 320 the information associated with the at least one energy harvesting device 130, the identity of the terminal device 110-1 and an identity of the terminal device 110-2 to the network device 120.

Upon receiving the information associated with the at least one energy harvesting device 130 as well as the identities of the terminal devices 110-1 and 110-2, the network device 120 determines 325, based at least on the information and the identities of the terminal devices 110-1 and 110-2, to attach the at least one energy harvesting device 130 to the terminal devices 110-1 and 110-2. For example, the network device 120 may determine, based at least on the information as well as the identities of the terminal devices 110-1 and 110-2, to attach at least one of the energy harvesting devices 130-1 and 130-2 to the terminal devices 110-1 and 110-2.

In turn, the network device 120 transmits 330, to the terminal device 110-2, a message indicating that the at least one energy harvesting device 130 is attached to the terminal device 110-2.

Similarly, the network device 120 transmits 335, to the terminal device 110-1, a message indicating that the at least one energy harvesting device 130 is attached to the terminal device 110-1.

Upon receiving the messages indicating that the at least one energy harvesting device 130 is attached to the terminal devices 110-1 and 110-2, the attachment of the at least one energy harvesting device 130 to the terminal devices 110-1 and 110-2 is completed.

In some example embodiments, the attachment of the at least one energy harvesting device 130 to the terminal devices 110-1 and 110-2 determines which illuminator may need to be used for communication with an energy harvesting device 130 and which reader may need to listen to the energy harvesting device 130 when the illuminator is active.

For example, in example embodiments where the energy harvesting device 130-1 is attached to the terminal device 110-1 acting the illuminator and to the terminal device 110-2 acting the reader, the terminal device 110-1 may need to be used for transmitting a signal to the energy harvesting device 130-1 and the terminal device 110-2 may need to be used for listening to the energy harvesting device 130-1.

Upon receiving the query, the energy harvesting device 130-1 transmits 340 a query result to the terminal device 110-2 and the energy harvesting device 130-2 transmits 345 a query result to the terminal device 110-2.

Upon receiving the query results from the energy harvesting devices 130-1 and 130-2, the terminal device 110-2 transmits 350 the query results to the network device 120.

In some example embodiments, the at least one energy harvesting device 130 may be not attached to the terminal device 110-2 for example due to mobility of at least one of the following: the at least one energy harvesting device 130 or the terminal device 110-2. In other words, the at least one energy harvesting device 130 may be not within a communication range of the terminal device 110-2.

In some example embodiments, optionally, if the terminal device 110-2 detects the at least one energy harvesting device 130 did not respond to the terminal device 110-2, the terminal device 110-2 may transmit 355, to the network device 120, a notification indicating the at least one energy harvesting device 130 did not respond to the terminal device 110-2.

Upon receiving the notification, the network device 120 may optionally transmit 275 the information message for re-attachment of the at least one energy harvesting device 130 to the terminal device 110-2.

It shall be noted that details of the example embodiments which have been describe with reference to FIG. 2 are also applicable to the process 300.

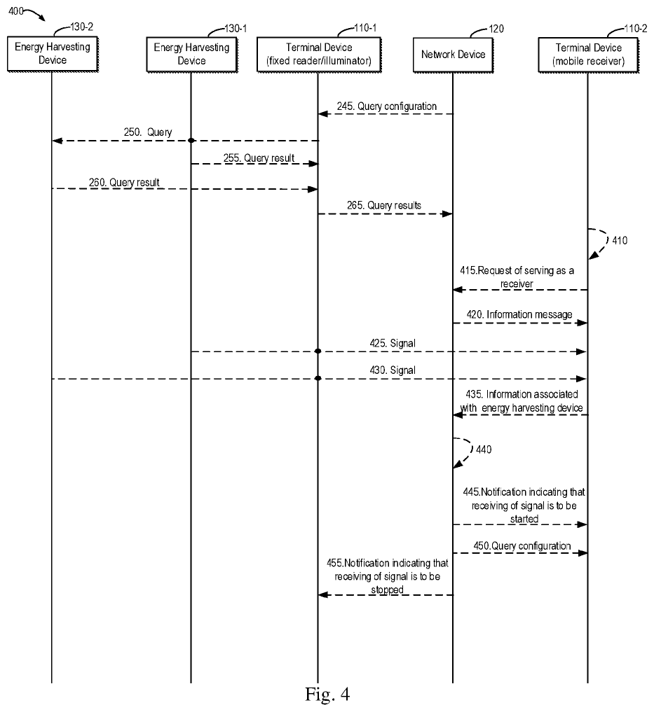

In some example embodiments, the energy harvesting devices 130 have high density and the terminal device 110 could be used just as a receiver. This configuration is called bistatic configuration. In the high-density areas, such as the area 140, reducing the number of illuminators can reduce the mutual interference between backscattered signals. Multiple mobile receivers on different directions could act as the receiver to assist fixed illuminator for the anti-collision purpose. This will be described with reference to FIG. 4.

FIG. 4 illustrates a signaling chart illustrating a process 400 for attachment of at least one energy harvesting device in accordance with still other example embodiments of the present disclosure. For the purpose of discussion, the process 400 will be described with reference to FIG. 1. The process 400 may involve the terminal device 110, the network device 120 and the energy harvesting devices 130 in FIG. 1. Hereinafter, the process 400 will be described using the terminal device 110-1, the terminal device 110-2, the network device 120 as well as the energy harvesting devices 130-1 and 130-2 for example.

In the process 400, the terminal device 110-1 may act as a reader/illuminator and the terminal device 110-2 may act as a mobile receiver. Alternatively, in the process 400, the terminal device 110-1 may act as a illuminator and the terminal device 110-2 may act as a mobile receiver. Alternatively, in the process 400, the terminal device 110-1 may act as a reader/illuminator and the terminal device 110-2 may act as a mobile reader/illuminator.

The actions at 245, 250, 255, 260 and 265 in the process 400 are similar to those in the process 200. Thus, details of these actions are omitted for brevity.

In addition, the actions at 210 to 240 in the process 200 may be performed in the process 400. Thus, these actions are not shown in FIG. 4 for brevity.

The process 400 is different from the process 200 in actions at 410, 415, 420, 425, 430, 435, 440, 445, 450 and 455 as discussed below.

As shown in FIG. 4, the terminal device 110-1 may enter 410 the cell 122 for example by physically entering the cell 122 or powering on while in the cell 122.

The terminal device 110-1 may transmit 415, to the network device 120, a request of serving as a receiver for the least one energy harvesting device 130.

In some example embodiments, the request of serving as the receiver may comprise at least one of the following:
an identity of the terminal device 110-2,
a location of the terminal device 110-2, or
capability information of the terminal device 110-2.

Upon receiving the request, the network device 120 transmits 420 a response to the request. The response may comprise the information message for attachment of at least one energy harvesting device 130 to the terminal device 110.

The energy harvesting device 130-1 broadcasts 425 a signal so that the terminal devices 110-1 and 110-2 may receive the signal based on the information message. In some examples, the information message may be broadcast periodically.

As described above, the signal from the energy harvesting device 130-1 may comprise at least an identity of the energy harvesting device 130-1. Alternatively or additionally, the signal may comprise any other assistance information to be used for attachment of the energy harvesting device 130-1.

Similarly, the energy harvesting device 130-2 broadcasts 430 a signal so that the terminal devices 110-1 and 110-2 may receive the signal based on the information message. In some examples, the information message may be broadcast periodically.

As described above, the signal from the energy harvesting device 130-2 may comprise at least an identity of the energy harvesting device 130-2. Alternatively or additionally, the signal may comprise any other assistance information to be used for attachment of the energy harvesting device 130-2.

Upon receiving the signals, the terminal device 110-2 transmits 435 information associated with the energy harvesting devices 130-1 and 130-2 and an identity of the terminal device 110-2 to the network device 120.

In some example embodiments, the information associated with the energy harvesting devices 130-1 and 130-2 may comprise at least one of the following: identities of the energy harvesting devices 130-1 and 130-2, or power measurements of the signals from the energy harvesting devices 130-1 and 130-2.

Upon receiving the information associated with the energy harvesting devices 130-1 and 130-2 as well as the identity of the terminal device 110-2, the network device 120 changes an attachment of at least one of the energy harvesting devices 130-1 and 130-2 based on at least one of the following: the number of the energy harvesting devices 130, power measurements of the signals from the energy harvesting devices 130, or the location of the terminal device 110-2.

For example, because the terminal device 110-2 is closer to the energy harvesting device 130-2 than the terminal device 110-1, the network device 120 may change the attachment of the energy harvesting device 130-2 from the terminal device 110-1 to the terminal device 110-2.

In example embodiments where the terminal device 110-2 is only implemented as a mobile receiver, the network device 120 may transmit 445, to the terminal device 110-2, a notification indicating that receiving of the signal from the energy harvesting device 130-2 is to be started.

In example embodiments where the terminal device 110-1 is implemented as a reader/illuminator or as a receiver, the network device 120 may transmit 455, to the terminal device 110-1, a notification indicating that receiving of the signal from the energy harvesting device 130-2 is to be stopped.

In example embodiments where the terminal device 110-2 is implemented as a mobile reader/illuminator, the network device 120 may transmit a notification to the terminal device 110-2 so as to indicate that receiving of the signal from the energy harvesting device 130-2 and transmitting a signal to the energy harvesting device 130-2 is to be started. The network device 120 may also transmit, to the terminal device 110-1, a notification indicating that the attachment of the energy harvesting device 130-2 is removed.

In addition, in order to obtain the query result of the energy harvesting device 130-2, the network device 120 may transmit 450 the query configuration to the terminal device 110-2.

With the process 400, the terminal device 110-2 acting as a mobile receiver may operate on a direction different from that of the terminal device 110-1 acting as a fixed illuminator so as to assist the fixed illuminator for the anti-collision purpose.

In addition, the terminal device 110-2 acting only as a mobile receiver will not increase the number of illuminators in the area 140, which can reduce the mutual interference between backscattered signals.

It shall be noted that details of the example embodiments which have been describe with reference to FIGS. 2 and 3 are also applicable to the process 400.

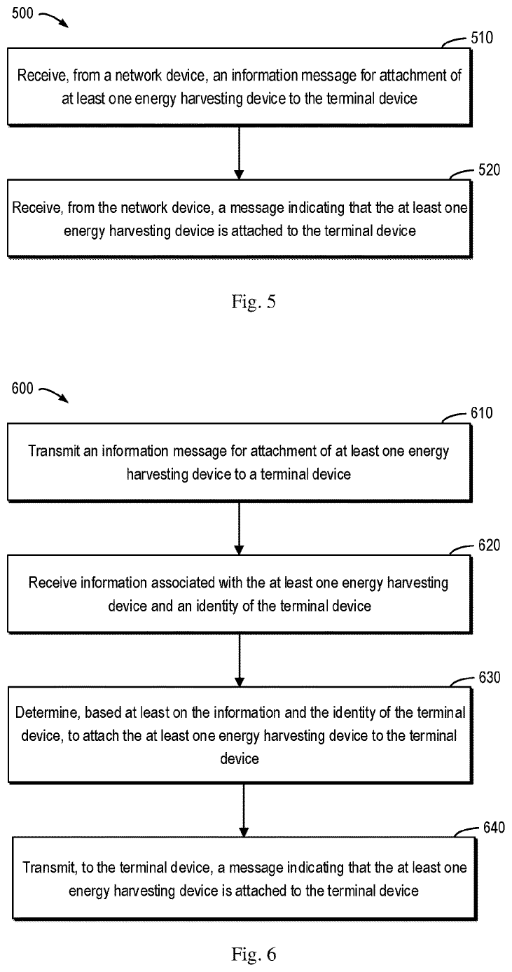

FIG. 5 shows a flowchart of an example method 500 implemented at a terminal device in accordance with some example embodiments of the present disclosure. For the purpose of discussion, the method 500 will be described from the perspective of the terminal device 110 with respect to FIG. 1.

At block 510, the terminal device 110 receives, from a network device, an information message for attachment of at least one energy harvesting device to the terminal device.

At block 520, the terminal device 110 receives, from the network device, a message indicating that the at least one energy harvesting device is attached to the terminal device.

In some example embodiments, the information message comprises at least one of the following: time when an illumination signal is to be transmitted, a bandwidth part on which the illumination signal is to be transmitted, a type of the at least one energy harvesting device which will receive the illumination signal, or a set of identities of energy harvesting devices comprising the at least one energy harvesting device.

In some example embodiments, the method 500 further comprises: receiving a signal from the at least one energy harvesting device based on the information message, the signal comprising at least an identity of the at least one energy harvesting device; and transmitting information associated with the at least one energy harvesting device and an identity of the terminal device to the network device.

In some example embodiments, the signal is at least one of the following: a backscattered signal from a passive energy harvesting device, or a transmitted signal from an active energy harvesting device.

In some example embodiments, the information associated with the at least one energy harvesting device comprises at least one of the following: an identity of the at least one energy harvesting device, or a power measurement of the signal.

In some example embodiments, the method 500 further comprises: transmitting an illumination signal based on the information message, the illumination signal comprising a request for the attachment.

In some example embodiments, the method 500 further comprises: receiving, from the network device, a query configuration for at least one attached energy harvesting device; receiving, based on the query configuration, a query result from the at least one attached energy harvesting device; and transmitting the query result to the network device.

In some example embodiments, the method 500 further comprises: transmitting, based on the query configuration, a query to the at least one attached energy harvesting device.

In some example embodiments, the query configuration comprises at least one of the following: an identity of the at least one energy harvesting device, a cycle in which a query is to be transmitted, or a bandwidth part on which the query is to be transmitted.

In some example embodiments, receiving the information message comprises:
transmitting, to the network device, a notification indicating the at least one energy harvesting device does not respond to the terminal device; and receiving a response to the notification from the network device, the response comprising the information message.

In some example embodiments, receiving the information message comprises receiving the information message periodically.

In some example embodiments, receiving the information message comprises: transmitting, to the network device, a request of serving as a receiver for the least one energy harvesting device; and receiving a response to the request from the network device, the response comprising the information message.

In some example embodiments, the request of serving as the receiver comprises at least one of the following: an identity of the terminal device, a location of the terminal device, or capability information of the terminal device.

In some example embodiments, the method 500 further comprises: receiving, from the network device, a notification indicating that receiving of a signal from the at least one energy harvesting device is to be stopped; or receiving, from the network device, a notification indicating that the attachment is removed.

FIG. 6 shows a flowchart of an example method 600 implemented at a network device in accordance with some example embodiments of the present disclosure. For the purpose of discussion, the method 600 will be described from the perspective of the network device 120 with respect to FIG. 1.

At block 610, the network device 120 transmits an information message for attachment of at least one energy harvesting device to a terminal device.

At block 620, the network device 120 receives information associated with the at least one energy harvesting device and an identity of the terminal device.

At block 630, the network device 120 determines, based at least on the information and the identity of the terminal device, to attach the at least one energy harvesting device to the terminal device.

At block 640, the network device 120 transmits, to the terminal device, a message indicating that the at least one energy harvesting device is attached to the terminal device.

In some example embodiments, the information message comprises at least one of the following: time when an illumination signal is to be transmitted, a bandwidth part on which the illumination signal is to be transmitted, a type of the at least one energy harvesting device which will receive the illumination signal, or a set of identities of energy harvesting devices comprising the at least one energy harvesting device.

In some example embodiments, the method 600 further comprises: transmitting an illumination signal based on the information message, the illumination signal comprising a request for the attachment.

In some example embodiments, the method 600 further comprises: transmitting, to the terminal device, a query configuration for at least one attached energy harvesting device; and receiving a query result from the terminal device.

In some example embodiments, the query configuration comprises at least one of the following: an identity of the at least one energy harvesting device, a cycle in which a query is to be transmitted, or a bandwidth part on which the query is to be transmitted.

In some example embodiments, the method 600 further comprises: transmitting, based on the query configuration, a query to the at least one energy harvesting device.

In some example embodiments, the information associated with the at least one energy harvesting device comprises at least one of the following: an identity of the at least one energy harvesting device, or power measurement of a signal from the at least one energy harvesting device.

In some example embodiments, transmitting the information message comprises: receiving, from the terminal device, a notification indicating the at least one energy harvesting device did not respond to the terminal device; and transmitting a response to the notification to the terminal device, the response comprising the information message.

In some example embodiments, transmitting the information message comprises: transmitting the information message periodically.

In some example embodiments, transmitting the information message comprises: receiving, from the terminal device, a request of serving as a receiver for the least one energy harvesting device; and transmitting a response to the request to the terminal device, the response comprising the information message.

In some example embodiments, the request of serving as the receiver comprises at least one of the following: an identity of the terminal device, a location of the terminal device, or capability information of the terminal device.

In some example embodiments, the method 600 further comprises: changing the attachment of the at least one energy harvesting device based at least on the information associated with the at least one energy harvesting device. Changing the attachment comprises: transmitting, to the terminal device, a notification indicating that receiving of a signal from the at least one energy harvesting device is to be stopped; and transmitting, to a further terminal device, a notification indicating that receiving of the signal is to be started.

In some example embodiments, the method 600 further comprises: changing the attachment of the at least one energy harvesting device based at least on the information associated with the at least one energy harvesting device; and transmitting, to the terminal device, a notification indicating that the attachment is removed.

In some example embodiments, an apparatus capable of performing any of the method 500 (for example, the terminal device 110) may comprise means for performing the respective operations of the method 500. The means may be implemented in any suitable form. For example, the means may be implemented in a circuitry or software module. The apparatus may be implemented as or included in the terminal device 110. In some example embodiments, the means may comprise a processor and a memory.

In some example embodiments, the apparatus comprises: means for receiving, at a terminal device from a network device, an information message for attachment of at least one energy harvesting device to the terminal device; and means for receiving, from the network device, a message indicating that the at least one energy harvesting device is attached to the terminal device.

In some example embodiments, the information message comprises at least one of the following: time when an illumination signal is to be transmitted, a bandwidth part on which the illumination signal is to be transmitted, a type of the at least one energy harvesting device which will receive the illumination signal, or a set of identities of energy harvesting devices comprising the at least one energy harvesting device.

In some example embodiments, the apparatus further comprises: means for receiving a signal from the at least one energy harvesting device based on the information message, the signal comprising at least an identity of the at least one energy harvesting device; and means for transmitting information associated with the at least one energy harvesting device and an identity of the terminal device to the network device.

In some example embodiments, the signal is at least one of the following: a backscattered signal from a passive energy harvesting device, or a transmitted signal from an active energy harvesting device.

In some example embodiments, the information associated with the at least one energy harvesting device comprises at least one of the following: an identity of the at least one energy harvesting device, or a power measurement of the signal.

In some example embodiments, the apparatus further comprises: means for transmitting an illumination signal based on the information message, the illumination signal comprising a request for the attachment.

In some example embodiments, the apparatus further comprises: means for receiving, from the network device, a query configuration for at least one attached energy harvesting device; means for receiving, based on the query configuration, a query result from the at least one attached energy harvesting device; and means for transmitting the query result to the network device.

In some example embodiments, the apparatus further comprises: means for transmitting, based on the query configuration, a query to the at least one attached energy harvesting device.

In some example embodiments, the query configuration comprises at least one of the following: an identity of the at least one energy harvesting device, a cycle in which a query is to be transmitted, or a bandwidth part on which the query is to be transmitted.

In some example embodiments, the means for receiving the information message comprises: means for transmitting, to the network device, a notification indicating the at least one energy harvesting device did not respond to the terminal device; and means for receiving a response to the notification from the network device, the response comprising the information message.

In some example embodiments, the means for receiving the information message comprises means for receiving the information message periodically.

In some example embodiments, the means for receiving the information message comprises: means for transmitting, to the network device, a request of serving as a receiver for the least one energy harvesting device; and means for receiving a response to the request from the network device, the response comprising the information message.

In some example embodiments, the request of serving as the receiver comprises at least one of the following: an identity of the terminal device, a location of the terminal device, or capability information of the terminal device.

In some example embodiments, the apparatus further comprises: means for receiving, from the network device, a notification indicating that receiving of a signal from the at least one energy harvesting device is to be stopped; or means for receiving, from the network device, a notification indicating that the attachment is removed.

In some example embodiments, an apparatus capable of performing any of the method 600 (for example, the network device 120) may comprise means for performing the respective operations of the method 600. The means may be implemented in any suitable form. For example, the means may be implemented in a circuitry or software module. The apparatus may be implemented as or included in the network device 120. In some example embodiments, the means may comprise a processor and a memory.

In some example embodiments, the apparatus comprises: means for transmitting, from a network device to a terminal device, an information message for attachment of at least one energy harvesting device; means for receiving information associated with the at least one energy harvesting device and an identity of the terminal device; means for determining, based at least on the information and the identity of the terminal device, to attach the at least one energy harvesting device to the terminal device; and means for transmitting, to the terminal device, a message indicating that the at least one energy harvesting device is attached to the terminal device.

In some example embodiments, the information message comprises at least one of the following: time when an illumination signal is to be transmitted, a bandwidth part on which the illumination signal is to be transmitted, a type of the at least one energy harvesting device which will receive the illumination signal, or a set of identities of energy harvesting devices comprising the at least one energy harvesting device.

In some example embodiments, the apparatus further comprises: means for transmitting an illumination signal based on the information message, the illumination signal comprising a request for the attachment.

In some example embodiments, the apparatus further comprises: means for transmitting, to the terminal device, a query configuration for at least one attached energy harvesting device; and means for receiving a query result from the terminal device.

In some example embodiments, the query configuration comprises at least one of the following: an identity of the at least one energy harvesting device, a cycle in which a query is to be transmitted, or a bandwidth part on which the query is to be transmitted.

In some example embodiments, the apparatus further comprises: means for transmitting, based on the query configuration, a query to the at least one energy harvesting device.

In some example embodiments, the information associated with the at least one energy harvesting device comprises at least one of the following: an identity of the at least one energy harvesting device, or power measurement of a signal from the at least one energy harvesting device.

In some example embodiments, the means for transmitting the information message comprises: means for receiving, from the terminal device, a notification indicating the at least one energy harvesting device did not respond to the terminal device; and means for transmitting a response to the notification to the terminal device, the response comprising the information message.

In some example embodiments, the means for transmitting the information message comprises: means for transmitting the information message periodically.

In some example embodiments, the means for transmitting the information message comprises: means for receiving, from the terminal device, a request of serving as a receiver for the least one energy harvesting device; and means for transmitting a response to the request to the terminal device, the response comprising the information message.

In some example embodiments, the request of serving as the receiver comprises at least one of the following: an identity of the terminal device, a location of the terminal device, or capability information of the terminal device.

In some example embodiments, the apparatus further comprises: means for changing the attachment of the at least one energy harvesting device based at least on the information associated with the at least one energy harvesting device. The means for changing the attachment comprises: means for transmitting, to the terminal device, a notification indicating that receiving of a signal from the at least one energy harvesting device is to be stopped; and means for transmitting, to a further terminal device, a notification indicating that receiving of the signal is to be started.

In some example embodiments, the apparatus further comprises: means for changing the attachment of the at least one energy harvesting device based at least on the information associated with the at least one energy harvesting device; and means for transmitting, to the terminal device, a notification indicating that the attachment is removed.

FIG. 7 is a simplified block diagram of a device 700 that is suitable for implementing embodiments of the present disclosure. The device 700 may be provided to implement the communication device, for example, the terminal device 110 or the network device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 1 to 6. The embodiments of the present disclosure may also be implemented by hardware or by a combination of software and hardware.

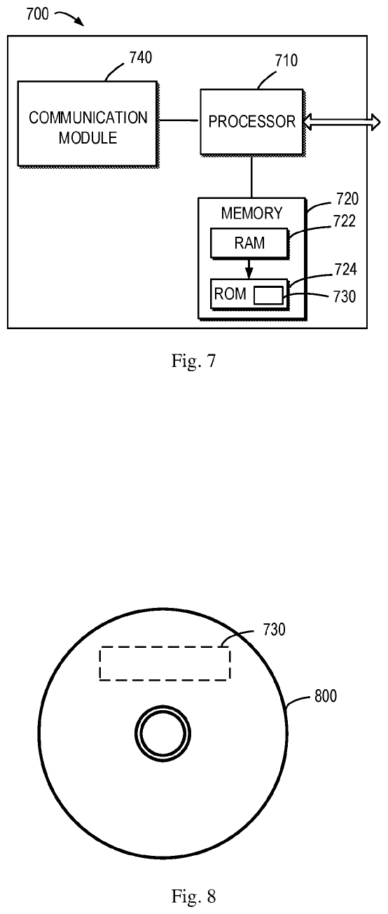

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 500 to 600 as described above with reference to FIGS. 5 to 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device, comprising:
at least one processor; and
at least one memory storing instructions that, when executed by the at least one processor, cause the terminal device at least to:
receive, from a network device, an information message for attachment of at least one energy harvesting device to the terminal device; and
receive, from the network device, a message indicating that the at least one energy harvesting device is attached to the terminal device.

2. The terminal device of claim 1, wherein the information message comprises at least one of the following:
time when an illumination signal is to be transmitted,
a bandwidth part on which the illumination signal is to be transmitted,
a type of the at least one energy harvesting device which will receive the illumination signal, or
a set of identities of energy harvesting devices comprising the at least one energy harvesting device.

3. The terminal device of claim 1, wherein the terminal device is further caused to:
receive a signal from the at least one energy harvesting device based on the information message, the signal comprising at least an identity of the at least one energy harvesting device; and
transmit information associated with the at least one energy harvesting device and an identity of the terminal device to the network device.

4. The terminal device of claim 3, wherein the signal is at least one of the following:
a backscattered signal from a passive energy harvesting device, or
a transmitted signal from an active energy harvesting device.

5. The terminal device of claim 3, wherein the information associated with the at least one energy harvesting device comprises at least one of the following:
an identity of the at least one energy harvesting device, or
a power measurement of the signal.

6. The terminal device of claim 1, wherein the terminal device is further caused to:
transmit an illumination signal based on the information message, the illumination signal comprising a request for the attachment.

7. The terminal device of claim 1, wherein the terminal device is further caused to:
receive, from the network device, a query configuration for at least one attached energy harvesting device;
receive, based on the query configuration, a query result from the at least one attached energy harvesting device; and
transmit the query result to the network device.

8. The terminal device of claim 7, wherein the terminal device is further caused to:
transmit, based on the query configuration, a query to the at least one attached energy harvesting device.

9. The terminal device of claim 7, wherein the query configuration comprises at least one of the following:
an identity of the at least one energy harvesting device,
a cycle in which a query is to be transmitted, or
a bandwidth part on which the query is to be transmitted.

10. The terminal device of claim 1, wherein the terminal device is caused to receive the information message by:
transmitting, to the network device, a notification indicating the at least one energy harvesting device did not respond to the terminal device; and
receiving a response to the notification from the network device, the response comprising the information message.

11. The terminal device of claim 1, wherein the terminal device is caused to receive the information message periodically.

12. The terminal device of claim 1, wherein the terminal device is caused to receive the information message by:
transmitting, to the network device, a request of serving as a receiver for the least one energy harvesting device; and
receiving a response to the request from the network device, the response comprising the information message.

13. The terminal device of claim 12, wherein the request of serving as the receiver comprises at least one of the following:
an identity of the terminal device,
a location of the terminal device, or
capability information of the terminal device.

14. The terminal device of claim 1, wherein the terminal device is further caused to:
receive, from the network device, a notification indicating that receiving of a signal from the at least one energy harvesting device is to be stopped; or
receive, from the network device, a notification indicating that the attachment is removed.

15. A network device, comprising:
at least one processor; and
at least one memory storing instructions that, when executed by the at least one processor, cause the network device at least to:
transmit an information message for attachment of at least one energy harvesting device to a terminal device;
receive information associated with the at least one energy harvesting device and an identity of the terminal device;
determine, based at least on the information and the identity of the terminal device, to attach the at least one energy harvesting device to the terminal device; and
transmit, to the terminal device, a message indicating that the at least one energy harvesting device is attached to the terminal device.

16. The network device of claim 15, wherein the information message comprises at least one of the following:
time when an illumination signal is to be transmitted,
a bandwidth part on which the illumination signal is to be transmitted,
a type of the at least one energy harvesting device which will receive the illumination signal, or
a set of identities of energy harvesting devices comprising the at least one energy harvesting device.

17. The network device of claim 15, wherein the network device is further caused to:
transmit an illumination signal based on the information message, the illumination signal comprising a request for the attachment.

18. The network device of claim 15, wherein the network device is further caused to:
transmit, to the terminal device, a query configuration for at least one attached energy harvesting device; and
receive a query result from the terminal device.

19. The network device of claim 18, wherein the query configuration comprises at least one of the following:
an identity of the at least one energy harvesting device,
a cycle in which a query is to be transmitted, or
a bandwidth part on which the query is to be transmitted.

20-27. (canceled)

28. A method, comprising:
receiving, at a terminal device from a network device, an information message for attachment of at least one energy harvesting device to the terminal device; and
receiving, from the network device, a message indicating that the at least one energy harvesting device is attached to the terminal device.

29-32. (canceled)
